(19) United States
(12) Patent Application Publication
(10) Pub. No.: US 2008/0025777 A1
(43) Pub. Date: Jan. 31, 2008

(54) Apparatus and method for detecting sheet to image registration

(75) Inventors: Tom Nagel, Venlo (NL); Haasan Nnafie, Eindhoven (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V.

(21) Appl. No.: 11/882,044

(22) Filed: Jul. 30, 2007

(30) Foreign Application Priority Data
Jul. 31, 2006 (EP) 06118174.9

(51) Int. Cl. G03G 15/00

(52) U.S. Cl. 399/396

(57) ABSTRACT

A method and apparatus for detecting sheet to image registration of images being transferred from an intermediate image carrier to the sheet.

This application claims priority from European Patent Application No. 06118174.9 filed on Jul. 31, 2006, the entire contents of which is hereby incorporated by reference.

### BACKGROUND OF THE INVENTION

The present invention relates to an apparatus for detecting sheet to image registration. The invention further relates to a method for detecting sheet to image registration by means of such an apparatus.

Electrophotographic printer devices, such as laser printers, are known per se. In these devices, a latent charge image of the image to be printed is generated on an intermediate image carrier, such as a photoconductor drum, which charge image is developed and transfer-printed onto a recording medium, commonly a sheet, and which is simultaneously or subsequently fixed onto the sheet by fusing. Finally the printed sheet is fed potentially after having been subjected to in-line finishing operations to a sheet deposit location where the finished printed sheets or sets of sheets are assembled. Due to the transfer-print process step, necessary to transfer a developed image from the intermediate image carrier to a sheet acting as the final image carrier, the position of the transferred image relative to the sheet is relatively critical and can easily become destabilised, for example, become shifted, wherein wear and tear of certain printer parts commonly cause said destabilisation of the sheet-image registration. The sheet to image registration may be detected and analyzed by periodically performing measurements on a finished printed sheet, preferably a finished printed calibration sheet, using a separate conventional scanning device. A printed calibration sheet is a sheet which has been processed by the printer so as to form a predetermined reference image thereon for calibration, purposes. In case considerable recording errors in the sheet to image registration have been found, the printer may be (re)calibrated, manually. However, this known method is relatively laborious, time-consuming, and hence expensive.

### SUMMARY OF THE INVENTION

It is an object of the present invention to provide an improved apparatus for detecting sheet to image registration.

This object can be achieved by providing an apparatus including transfer means for transferring at least one image carried on an intermediate image carrier to a sheet, detection means positioned downstream of the transfer means and downstream of a fusing means for detecting the position of the transferred image relative to the sheet, and advancing means for advancing the sheet along the transfer means and the detection means, wherein the advancing means controls the nominal position of the sheet as the sheet advances past the transfer means. The apparatus for sheet to image registration comprising a transfer means, detection means and advancing means, as described above, is disclosed in U.S. Pat. No. 5,555,084 (Vetromile et al.). The sheet to image registration disclosed in this reference is performed on a latent image on an intermediate image carrier, not on a transferred image.

By first transferring an image produced onto an intermediate image carrier, and thereafter, in-line, detecting the position of the transferred image relative to the sheet, sheet to image registration can be detected in a relatively quick, inexpensive and hence efficient manner. Moreover, due to the relatively efficient in-line sheet to image registration detection, the apparatus according to the present invention may be designed in a relatively compact manner. Separate components, such as a separate (conventional) scanning device, are no longer required to perform an adequate sheet to image registration detection, which is further advantageous due to the cost to perform an adequate detection of sheet to image registration. The in-line sheet to image registration detection provides (feedback) information about the accuracy of the printing process. In the case where the printing accuracy is decreased to an accuracy below a predefined accuracy limit, the apparatus, according to the present invention may be (re)calibrated based on the gathered information. It should be noted that the expression ‘sheet’ needs to be interpreted in a relatively broad sense in this context. Although paper sheets are commonly advanced through the apparatus according to the present invention, it is also conceivable for a person skilled in the art to apply other types of recording media, such as, e.g., plastic sheets, photographic films, and printable optical digital media (CD/DVD).

In order to further improve the reliability of the detection results gathered by the detection means, the advancing means are preferably adapted for advancing a sheet in a substantially predetermined orientation relative to the detection means. In this manner, the conditions under which the position of an image relative to the sheet is detected, can be held relatively similar, which is advantageous for the accuracy of the sheet to image detection. In a particular preferred embodiment the advancing means are provided with suction means for forcing a sheet to advance at a substantially constant distance from the detection means to a position past the detection means. In this manner the distance between the light source and an advancing sheet, and the distance between the optical sensor and an advancing sheet is predefined, as a result of which, the detection process can be performed more precisely.

In one embodiment, the detection means comprises at least one light source for illuminating a detection area, and at least one optical sensor for detecting the quantity of light reflected and/or transmitted by the detection area. By means of an assembly of at least one light source, preferably formed by a Light-Emitting Diode (LED), and an optical sensor, preferably formed by a photodiode, the position of the image relative to the sheet can be detected in a relatively cheap though efficient manner. To improve the efficiency of the detection system, the detection system may further include at least one lens for converging light generated by the light source in the direction of the detection area. In this manner the quantity of light reflected by the detection area in the direction of the optical sensor can be increased, resulting in an improved accuracy of the detection means. The detection area will commonly be situated in a predefined transport path through which a sheet is advanced, and may therefore make up part of the advancing system.

According to another embodiment of the present invention the apparatus further includes a controller for determining the position of the transferred image relative to the sheet after passing the detection system. Determination of the position of an image relative to the sheet is commonly realized by means of algorithms. Based on the image position calculated by the controller the print accuracy can be determined, and, in the case where the print accuracy becomes undesirable, a calibration process can be initiated to (re)calibrate the apparatus according to the present invention. Preferably, the print accuracy is monitored continuously, wherein calibration of the apparatus may also take place continuously in the case where a recording error is monitored, independent of the size and/or number of recording errors. A filter may be applied to suppress noise. In order to improve the analyzing process performed by the apparatus in order to determine the print accuracy of the apparatus according to the present invention, the apparatus preferably further includes comparing means for comparing the detected position of the image relative to the sheet with the (predefined) desired position of the image relative to the sheet, to determine sheet positioning errors produced by the advancing means. The comparing means may be part of the controller. Based on the comparative information, the controller will determine eventual deviations from the normal print accuracy, and hence determine an eventual need to adjust the apparatus according to the present invention.

The apparatus is preferably formed by a printer having one or more intermediate image carriers. Examples of intermediate image carriers are drums or belts. The intermediate image carriers are typically provided with an image forming surface layer such as, e.g., a photoconductive layer and/or a surface layer with good release properties such as, e.g., a silicone layer or a fluorosilicone layer. Examples of such printers include magnetic printers, electrostatic printers, including electrophotographic printers and inkjet printers. For instance, electrophotographic printing involves a selective discharging of a photoconductive surface by exposure to light. The exposure produces a latent image on the surface that will either attract or repel charged toner particles. The toner can be transported to the surface by dry carrier beads or suspended in a liquid vehicle in order to develop the latent image on the photoconductive surface. The developed toner image is subsequently transferred directly or via one or more further intermediate image carriers to the sheet surface. The toner is then fused to the sheet surface by heat and pressure. In inkjet printers, print heads, each having a plurality of nozzles, are used to write images on a receiving member. These images are typically formed by image-wise controlling actuators associated with the nozzles to expel ink droplets from the nozzles in the direction of the receiving member. Any kind of ink may be used as long as it is in fluid form when discharged, including aqueous inks, solvent inks, UV-curable inks and hot melt inks. Various kinds of actuators are known in the field of ink jet printing including thermal actuators as well as piezo-electrical actuators. The receiving member may be an intermediate image carrier on which the images are formed and subsequently transferred directly or via one or more further intermediate image carriers to a sheet surface. According to this invention it is conceivable to apply the apparatus, e.g., as a monochrome or full color printer, as a fax machine, and/or as a (photo)copier.

The present invention also relates to a method for detecting sheet to image registration by means of the present apparatus, comprising the steps of: A) advancing a sheet along transfer means for transferring at least one image produced on an intermediate image carrier to said sheet, B) detecting the position of the at least one transferred image relative to the sheet, and C) comparing the apparent position of the at least one image relative to the sheet with the actual position of the at least one image relative to the sheet, to determine sheet positioning errors. Advantages of this method according to the invention have already been elucidated above in a comprehensive manner.

In one embodiment of the method according to the present invention the position of the transferred image relative to at least one sheet edge is determined during step B). In this manner, the sheet edge will be used as a reference position relative to which the positioning of the transferred image is determined by means of the detection system.

In an alternative embodiment of the method according to the present invention, multiple images are transferred from the intermediate image carrier onto the sheet during step A) (and during a single apparatus passage). In this manner, the mutual distance between a sheet edge and each of the transferred images can be determined for optimising the sheet to image registration. In a particular preferred embodiment, the relative (mutual) position of the multiple transferred images is detected during step B). Preferably, the distance between the transferred images is predetermined, wherein the images are printed at precisely known longitudinal intervals. In this context, each individual calibration mark, such as for example a calibration line, is considered as an individual image.

In a further embodiment at least one image is formed by a calibration mark being transferred onto the (calibration) sheet. To perform the sheet to image registration detection, and eventually to calibrate the paper advance mechanism, the calibration sheet is advanced through the apparatus while the optical sensor is positioned to detect the one or more calibration marks. Calibration logic calculates the apparent space intervals between adjacent calibration marks, and eventually between the calibration mark(s) and a sheet edge, and compares them with the known intervals to determine the positioning error of the calibration mark(s).

During step B) the advancing sheet is preferably forced, in a substantially predetermined orientation, along the detection system which favors detection reliability. In a particular preferred embodiment, during step B) the advancing sheet is forced by means of a suction in a predetermined orientation relative to the detection system. In this manner the distance between the advancing sheet and the detection system will be held substantially constant, thereby further increasing the accuracy of the sheet to image registration.

In this context it is noted that the controller of the apparatus according to the present invention will commonly be adapted to determine the position of the transferred image relative to the sheet after passing the detection system and also perform the method according to the present invention.

### BRIEF DESCRIPTION OF THE DRAWINGS

The present invention will be illustrated by means of the following non-limitative embodiment, wherein:

FIG. 1 shows a side view of a laser printer according to the present invention, and

FIG. 2 shows a top view of a calibration sheet for use in the laser printer according to FIG. 1.

### DETAILED DESCRIPTION OF THE INVENTION

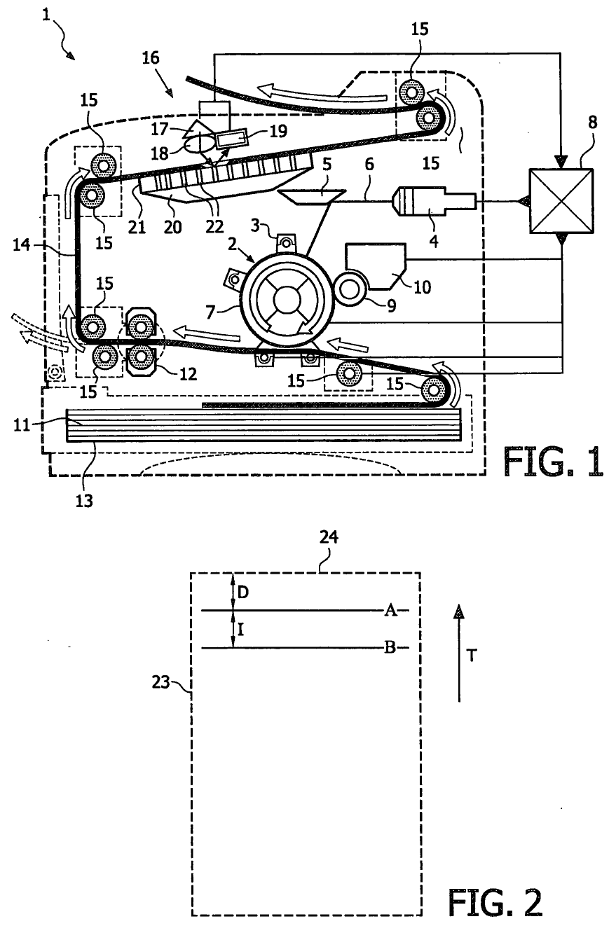

FIG. 1 shows a side view of a laser printer 1 according to the present invention. The laser printer 1 comprises a rotatable, drum-shaped photoreceptor 2 made of photoconductive material. The laser printer 1 also comprises an electrical wire 3, also known as a corona wire, for selectively providing the photoreceptor 2 with a positive charge. By means of an optical assembly of a (diode) laser 4 and one or more lenses 5 (of which merely one is shown) a laser beam 6 is focussed on the external surface 7 of the photoreceptor 2 to enable photons to discharge position-selective areas of the surface representing an electrostatic image representing a negative image of an image stored in a controller 8 of the laser printer 1. Subsequently, the photoreceptor 2 being positively charged, is covered with toner powder 9 which sticks to the discharged areas of the photoreceptor 2. The toner 9 is initially held by a toner hopper 10. Then the rotating photoreceptor 2 passes along an advancing sheet 11, commonly made of paper, which sheet was given a negative charge, stronger than the negative charge of the electrostatic image. As a result, the sheet will attract the toner powder 9, thereby transferring the negative image onto sheet 11 as a positive image. Finally, the laser printer 1 passes the sheet 11 through a pair of heated rollers 12, also known as the fuser, melting the toner powder 9 into the sheet and hence finalizing the sheet 11. The sheets 11 are initially held by a sheet tray 13 and are advanced through the laser printer 1 via a predefined path 14 (indicated by arrows) by means of multiple advancing rollers 15. The rollers 15, the photoreceptor 2, the toner hopper 10, and the laser 4 are all controlled by the controller 8 to make sure the photoreceptor 2 and the advancing sheets 11 are moving with exactly the same speeds to optimise the image transfer, and hence the print quality. However, due to wear of certain components, e.g., of the advancing rollers 15, of the laser printer 1, the sheet to image registration can become unstable in time. To monitor a shift in the sheet to image registration the laser printer 1 also comprises a detection system 16 for detecting the position of the transferred image(s) relative to the sheet 11. The detection system 16 comprises an optical assembly of a light source 17, in particularly a LED, and a lens 18 for focussing light generated by the light source 17 in the direction of the sheet path 14. Light reflected by the sheet path 14 and/or by a sheet 11 advancing in said sheet path 14 can be observed by a photodiode 19. Although the photodiode 19 is positioned next to the light source 17 in this non-limitative embodiment, it can be also imagined to position the photodiode 19 and the light source 17 opposite to each other, wherein the sheet path 14 is disposed therebetween. In this latter case, light transmission through the sheet will be detected rather than light reflection. By measuring the quantity of light reflection, both the sheet edge of the sheet 11 and the image printed onto that sheet 11 can be observed. To improve the accuracy of the detection system 16 a suction device 20 is provided to realize a substantially constant distance between a passing sheet 11 and the detection system 16. The suction device 20 comprises a smooth plate 21 provided with multiple perforations 22 through which an under pressure is generated in the sheet path 14 enclosed by the detection system 16. The sheet to image registration results gathered by the detection system 16 are transferred to the controller 8 to determine eventual recording errors. In case recording errors are detected by the controller 8, the controller 8 will commonly calibrate the advancing rollers 15 and/or the photoreceptor 2 and/or timing of the laser beam 6 to correct the sheet to image registration. In this manner, sheet to image registration detection can be performed in-line with the printing process and within the same apparatus 1. In this way, sheet to image registration can be detected in a relatively quick, efficient and relatively cheap manner.

FIG. 2 shows a top view of a calibration sheet 23 for use in the laser printer 1 according to FIG. 1. The calibration sheet 23 is adapted to be advanced through the laser printer 1 in the direction of arrow T. Two calibration lines (line A and line B) are printed with a known interval I (5 millimeter) onto the sheet 1 close to a front edge 24 of the sheet 23. Moreover, the apparent position of line A relative to the front sheet edge 24 is also known and is defined at 5 millimeter in this example. By advancing this sheet 23 through the detection system 16 of the laser printer 1 the front sheet edge 24 and both calibration lines A and B are detected. The actual position D of line A relative to the front sheet edge can be calculated by the following formula:

$$D = \frac{{time}_{edge -> lineA}}{{time}_{lineA -> lineB}} \times I$$

wherein time_{edge→lineA} must be interpreted as the time difference detected between the detection of the front edge 24 and the detection of line A, wherein time_{lineA→lineB} must be interpreted as the time difference detected between the detection of line A and the detection of line B. A major advantage of this method of determining the actual position of line A is that no parameters are used relating to the speed of the advancing sheet, since this speed may not be continuously constant in time. By eliminating this uncertain or unreliable speed parameter, the accuracy of this method using multiple calibration lines (instead of merely a single calibration line) can be improved significantly. The calculated actual distance of line A relative to the front sheet edge 24 can be compared with the apparent position of this line A. As a consequence, possible recording errors of the laser printer 1 will be revealed. In case recording errors are revealed during this comparison step, a calibration step may be performed to counteract recording errors during future print jobs.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for detecting sheet to image registration, comprising:
transfer means for transferring at least one image carried on an intermediate image carrier to a sheet,
detection means positioned downstream of said transfer means and downstream of a fusing means for detecting the position of the transferred image relative to the sheet, and
advancing means for advancing said sheet along the transfer means and along the detection means, wherein the advancing means controls the nominal position of the sheet as the sheet advances past the transfer means.

2. The apparatus according to claim 1, wherein the advancing means are provided with suction means for forcing a sheet to advance, at a substantially constant distance past the detection means.

3. The apparatus according to claim 1, wherein the detection means comprises at least one light source for illuminating a detection area, and at least one optical sensor for detecting the quantity of light reflected by the detection area.

4. The apparatus according to claim 3, wherein the at least one light source is provided by a light-emitting diode (LED).

5. The apparatus according to claim 1, which further comprises a controller for determining the position of the transferred image relative to the sheet after passing the detection means.

6. The apparatus according to claim 1, which further comprises comparing means for comparing the detected position of the image relative to the sheet with the desired position of the image relative to the sheet to determine sheet positioning errors produced by the advancing means.

7. A method for detecting sheet to image registration comprising the steps of:
A) advancing a sheet along a transfer means for transferring at least one image produced onto an intermediate image carrier to said sheet,
B) detecting the position of at least one transferred image relative to the sheet, downstream of the said transfer means and downstream of the said fusing means, and
C) comparing the apparent position of at least one image relative to the sheet with the actual position of at least one image relative to the sheet to determine sheet positioning errors.

8. The method according to claim 7, wherein during step B) the position of the transferred image relative to at least one sheet edge is determined.

9. The method according to claim 7 wherein during step B) the advancing sheet is forced by means of suction in a predetermined orientation relative to the detection means.
